(19) United States
(12) Patent Application Publication
(10) Pub. No.: US 2015/0201459 A1
(43) Pub. Date: Jul. 16, 2015

(54) WIRELESS DEVICE INCLUDING WIRELESS ANTENNA

(71) Applicant: KABUSHIKI KAISHA TOSHIBA, Minato-ku (JP)

(72) Inventor: Keisuke SATO, Yokohama (JP)

(73) Assignee: KABUSHIKI KAISHA TOSHIBA, Minato-ku (JP)

(21) Appl. No.: 14/479,882

(22) Filed: Sep. 8, 2014

Related U.S. Application Data
(60) Provisional application No. 61/927,813, filed on Jan. 15, 2014.

(51) Int. Cl. H04W 88/06; H01Q 21/30; G06K 19/07; H01Q 7/00; G06K 19/077

(52) U.S. Cl. CPC H04W 88/06; H01Q 7/00; G06K 19/07783; G06K 19/07794; G06K 19/071; H01Q 21/30; H04W 84/12

(57) ABSTRACT

According to one embodiment, a wireless device includes a first antenna, a second antenna, and controller. The second antenna includes a loop pattern and a capacitor. The controller communicates by first communication using the first antenna and a ground, and communicates by second communication using the second antenna. The ground is electrically connected to the loop pattern.

### CROSS-REFERENCE TO RELATED APPLICATIONS

This application claims the benefit of U.S. Provisional Application No. 61/927,813, filed Jan. 15, 2014, the entire contents of which are incorporated herein by reference.

### FIELD

Embodiments described herein relate generally to a wireless device including a wireless antenna.

### BACKGROUND

Nowadays, wireless communication techniques are widely used. There are various wireless communication techniques, such as near field communication (NFC) using a frequency of 13.56 MHz, middle-distance or long-distance wireless communication (for example, wireless LAN (Local Area Network) such as IEEE 802.11) using a frequency of 2.4 GHz to 5.6 GHz, and ultra-high speed communication using a frequency of 4.48 GHz.

In recent years, semiconductor memory devices including a wireless LAN function have been made into products.

Since different frequencies are used for respective standards in the wireless communication techniques as described above, wireless communication devices include wireless antennas suitable for respective frequencies.

When a plurality of wireless communication techniques are used in a wireless communication device, the wireless communication device is required to include a plurality of wireless antennas having different characteristics corresponding to respective frequencies, and it is difficult to reduce the space and the cost.

### BRIEF DESCRIPTION OF THE DRAWING

FIG. 1 is a plan view illustrating a structure of a wireless device according to a first embodiment;

FIG. 2 is a circuit diagram illustrating the wireless device according to the first embodiment;

FIG. 3 is a plan view illustrating a conventional NFC antenna;

FIG. 4 is a plan view illustrating a wireless LAN antenna including an L-shaped pattern;

FIG. 5 is a plan view illustrating a wireless LAN antenna including an F-shaped pattern;

FIG. 6 is a plan view illustrating a structure of a wireless device according to a second embodiment;

FIG. 7 is a circuit diagram illustrating the wireless device according to the second embodiment;

FIG. 8 is a plan view illustrating a structure of a wireless device according to a third embodiment;

FIG. 9 is a circuit diagram illustrating the wireless device according to the third embodiment;

FIG. 10 is a plan view illustrating a structure of a wireless device according to a fourth embodiment;

FIG. 11 is a circuit diagram illustrating the wireless device according to the fourth embodiment;

FIG. 12 is a circuit diagram illustrating modified example of the wireless device according to the fourth embodiment;

FIG. 13 is a plan view illustrating a structure of a wireless device according to a fifth embodiment;

FIG. 14 is a circuit diagram illustrating the wireless device according to the fifth embodiment;

FIG. 15 is a diagram illustrating a front surface side of a memory card according to a sixth embodiment;

FIG. 16 is a diagram illustrating a back surface side of the memory card according to the sixth embodiment; and

FIG. 17 is a flowchart illustrating wireless communication between the memory card and a host device according to the sixth embodiment.

### DETAILED DESCRIPTION

Embodiments will be described hereinafter with reference to drawings. In a following description, the same reference numerals denote components having nearly the same functions and arrangements, and a repetitive description thereof will be given if necessary.

In general, according to one embodiment, a wireless device includes a first antenna, a second antenna, and a controller. The second antenna includes a loop pattern and a capacitor. The controller communicates by first communication using the first antenna and a ground, and communicates by second communication using the second antenna. The ground is electrically connected to the loop pattern.

### First Embodiment

The present embodiment shows a wireless device including a wireless antenna obtained by combining a plurality of wireless antennas of different types.

One of the wireless antennas is an antenna used for a radio wave of a first frequency band, for example, for a radio wave of middle or high frequency. The antenna for middle or high frequency is used for middle-distance or long-distance communication, such as a wireless LAN (Local Area Network). An example of wireless LAN is Wi-Fi (Wireless Fidelity) using a frequency of 2 GHz or higher (for example, about 2.4 GHz).

The other of the wireless antennas is an antenna used for a radio wave of a second frequency band which is less than the first frequency band, for example, for a radio wave of low frequency. More specifically, the other of the wireless antennas is an NFC antenna. In NFC, for example, a frequency of about 13.56 GHz is used.

However, communication systems according to the present embodiment are not limited to wireless LAN and NFC, but may be other communication systems.

Examples of the wireless device according to the present embodiment are a semiconductor memory device, a memory card, a USB memory, a portable information terminal, and a mobile phone, which include a wireless communication function.

FIG. 1 is a plan view illustrating a structure of the wireless device according to the present embodiment.

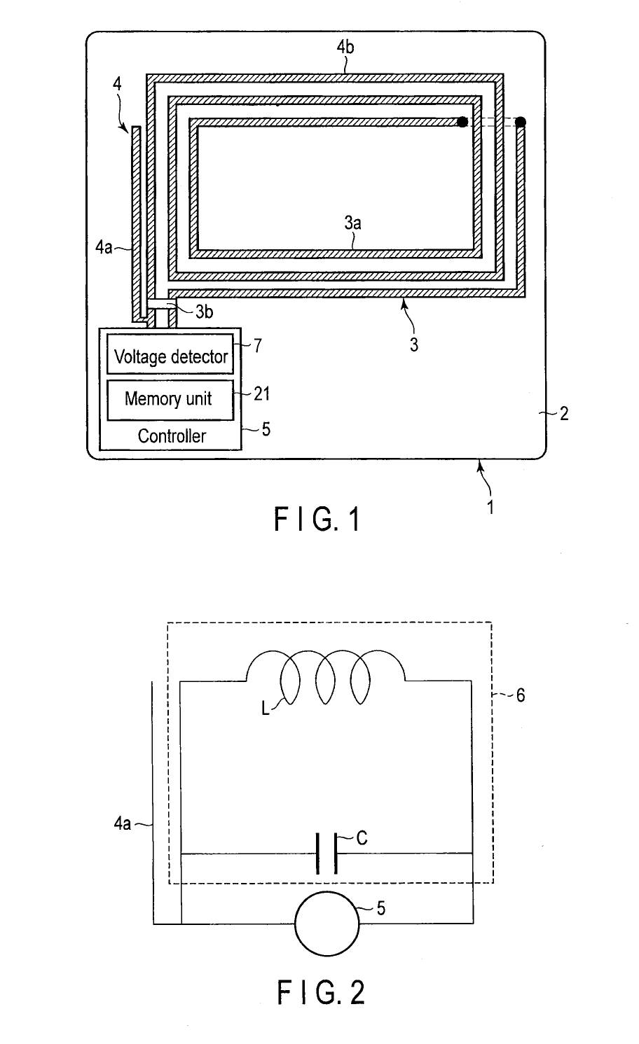

FIG. 2 is a circuit diagram illustrating the wireless device according to the present embodiment.

A wireless device 1 includes a board 2, an NFC antenna 3, a wireless LAN antenna 4, and a controller 5.

Although the present embodiment shows the case where the wireless device 1 includes one board 2, the wireless device 1 may include two or more boards 2s and have a multi-layer structure. In other words, in the present embodiment, constituent elements and wires of the wireless device 1 are formed on one surface or both surfaces of a two-layer board, but may be formed on a one-layer board or a multi-layer board having three or more layers.

The NFC antenna 3 includes a loop pattern 3a, and a capacitor 3b for adjusting a resonance frequency. In the present embodiment, it may be defined that a loop pattern generates electric power by a change of a magnetic flux density in an inside diameter space. For example, the loop pattern may be an annular pattern, a spiral pattern, a coiled pattern, or a scroll pattern. A main pattern in the loop pattern 3a is formed for a front surface of the board 2. The other part of the loop pattern 3a other than the main pattern is formed for a back surface of the board 2. In FIG. 1, the part formed for the back surface of the board 2 is denoted by dot lines. One end and the other end of the NFC antenna, that is, one end and the other end of the loop pattern 3a are electrically connected to the controller 5.

The NFC antenna 3 is set with a predetermined frequency (first frequency) or a frequency band corresponding to NFC.

The capacitor 3b adjusts a resonance frequency of the NFC antenna 3. One end of the capacitor 3b is connected to a part between the one end of the loop pattern 3a and the controller 5, and the other end of the capacitor 3b is connected to a part between the other end of the loop pattern 3a and the controller 5.

The NFC antenna 3 forms a resonance circuit 6 obtained by connecting an inductor L corresponding to the loop pattern 3a with a capacitor C corresponding to the capacitor 3b in parallel.

The wireless LAN antenna 4 includes an L-shaped pattern 4a. The L-shaped pattern 4a is electrically connected to the loop pattern 3a. The L-shaped pattern 4a is provided outside the resonance circuit 6. A shape of the wireless LAN antenna 4 is not limited to the L-shaped pattern 4a, but can be variously changed. For example, the wireless LAN antenna 4 may include an F-shaped pattern, instead of the L-shaped pattern 4a.

In the present embodiment, the wireless LAN antenna 4 uses at least part of the loop pattern 3a as an antenna ground 4b. In other words, part of the NFC antenna 3 is used as a signal ground for wireless LAN communication.

The wireless LAN antenna 4 is set with a predetermined frequency (second frequency) or a frequency band corresponding to wireless LAN.

The controller 5 communicates by wireless LAN using the wireless LAN antenna 4 and a ground. The ground is electrically connected to the loop pattern 3a. For example, the controller 5 may be communicates by wireless LAN when electrically connecting to a power supply device or an outside device and receiving electrical power from the power supply device. The controller 5 communicates by NFC using the NFC antenna 3. More specifically, the NFC antenna 3 and the wireless LAN antenna 4 are set with the first frequency and the second frequency, respectively. When the controller 5 receives a signal of the first frequency, the controller 5 starts with NFC communication system, and controls communication by NFC based on the first frequency. On the other hand, when the controller 5 receives a signal of the second frequency, the controller 5 starts with wireless LAN communication system, and controls communication by wireless LAN based on the second frequency.

The controller 5 can operate with reduced electric power. Specifically, the controller 5 can operate with electric power generated by electromagnetic induction with the NFC antenna 4.

The controller 5 includes a memory unit 21. The memory unit 21 can operate with electric power generated by electromagnetic induction with the NFC antenna 4. The controller 5 writes data to the memory unit 21 when receiving electric power generated in the NFC antenna 4, the data, and a data write command. The controller 5 reads the data from the memory unit 21 when receiving electric power generated in the NFC antenna 4 and a data read command. Data can be read out of and written in the memory unit 21 with reduced electric power, to enable communication between a memory card 18 and a host device by NFC in the case where no power is supplied to the memory card 18. The memory unit 21 is, for example, a nonvolatile memory. Although FIG. 1 illustrates a structure in which the controller 5 includes the memory unit 21, the controller 5 may be separated from the memory unit 21.

A voltage detector 7 included in the controller 5 monitors a voltage supplied to the controller 5, and continues to output a reset signal until the supplied voltage reaches a normal voltage. This structure prevents abnormal startup and abnormal operation of the wireless device 1.

In the present embodiment, the wireless LAN antenna 4 and the NFC antenna 3 are formed of a conductor, such as copper. The board 2 is formed of, for example, polychlorinated biphenyl (PCB).

An operation and effect of the wireless device 1 according to the present embodiment will be explained hereinafter.

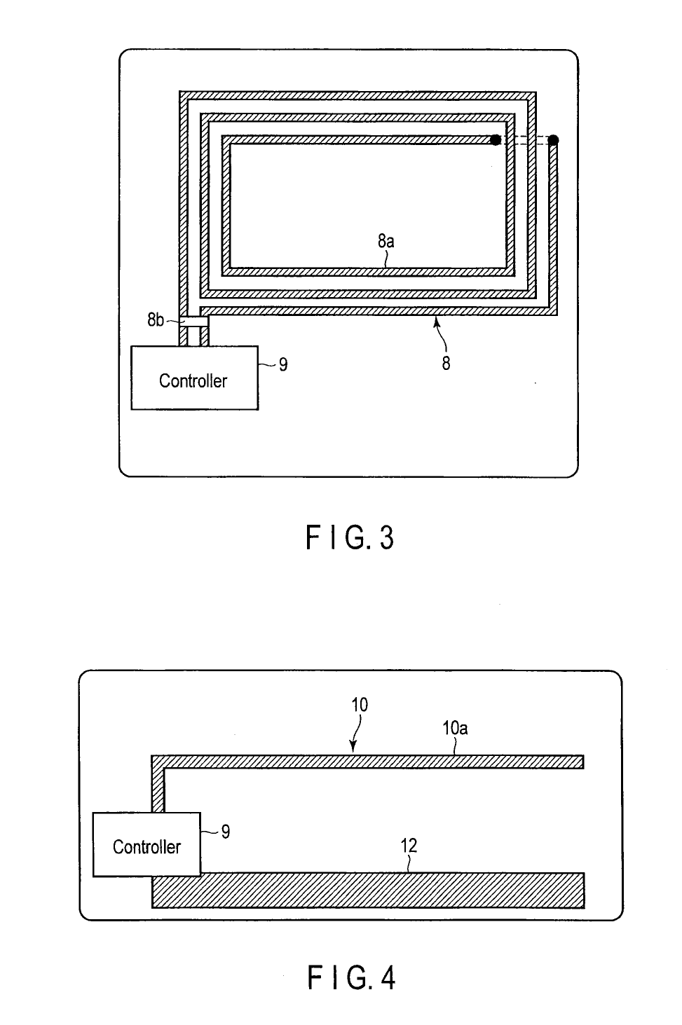

As illustrated in FIG. 3, a conventional NFC antenna 8 includes an LC parallel resonance circuit including a loop pattern 8a and a capacitor 8b. The conventional NFC antenna 8 is connected with a controller 9, and electrically communicates with an antenna of a reader/writer of a host device by electromagnetic induction. Thus, the NFC antenna 8 requires an inductance L having an area of a certain size. In other words, in the NFC antenna 8, it is necessary to secure a large opening area in the center part of the loop pattern 8a. So, it is necessary to secure a space of a certain size to form the NFC antenna 8.

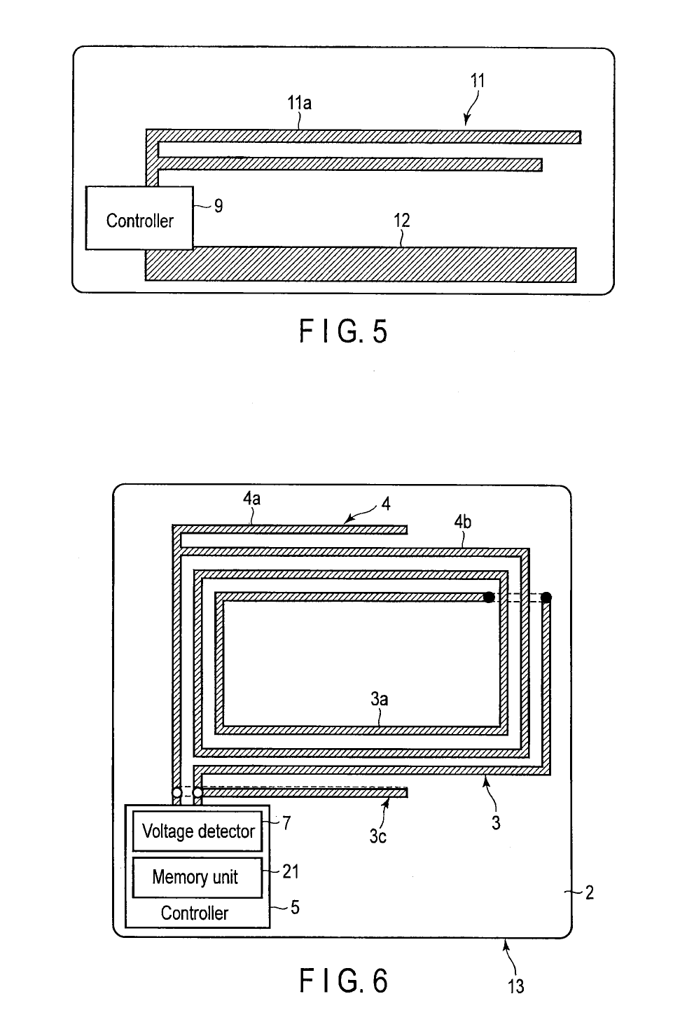

On the other hand, as examples of an ordinary wireless LAN antenna, there are a dipole antenna, a wireless LAN antenna 10 including an L-shaped pattern 10a as illustrated in FIG. 4, and a wireless LAN antenna 11 including an F-shaped pattern 11a as illustrated in FIG. 5. In the wireless LAN antennas 10 and 11 having the above structures, it is necessary to provide an antenna ground 12 of a large size.

If the wireless device is provided with the conventional NFC antenna 8 and the conventional wireless LAN antenna 10 or 11, it is necessary to provide the wireless device with the wireless antenna 9 and the wireless antenna 10 or 11 having different frequencies and structural features. Such a structure makes it difficult to reduce the space of the wireless device, increases the number of components, and makes it difficult to reduce the cost.

In comparison with this, the wireless device 1 according to the present embodiment has an antenna shape, layout, and a circuit structure that are different from those of the conventional device. The wireless device 1 according to the present embodiment has a wireless antenna structure obtained by combining the wireless LAN antenna 4 with the NFC antenna 3, and thereby achieves wireless LAN communication and NFC communication.

In the present embodiment, it is possible to use wireless techniques of different types in combination, such as wireless LAN and NFC. The use environment and the infrastructure are provided for wireless LAN and NFC. The wireless device 1 according to the present embodiment can access the same memory through the wireless antenna adapted to both the wireless LAN and the NFC standards, and the convenience of wireless LAN and NFC can be markedly improved.

In the present embodiment, the frequency of the wireless LAN antenna 4 can be easily adjusted, by adjusting the length of the L-shaped pattern 4a. In addition, according to the present embodiment, since the wireless LAN antenna 4 is provided outside the NFC antenna 3, the frequencies of the wireless LAN antenna 4 and the NFC antenna 3 can be easily adjusted.

In the present embodiment, since part of the NFC antenna 3 is used as the antenna ground 4b of the wireless LAN antenna 4, it is unnecessary to form the antenna ground 4b independently. Since at least part of the NFC antenna 3 also serves as at least part of the wireless LAN antenna 4 in the present embodiment, the present embodiment achieves reduction in space of the wireless antenna, reduces the number of components of the wireless device 1, and reduces the cost of the wireless device 1.

Since the present embodiment is provided with the memory unit 21, data transmission and reception can be performed by communication using NFC even in the case where the wireless device 1 includes no power supply device and is not supplied with electric power from outside.

### Second Embodiment

The present embodiment shows a wireless device that is a modification of the first embodiment, and includes the L-shaped pattern 4a of the wireless LAN antenna 4 inside the resonance circuit 6 of the NFC antenna 3.

FIG. 6 is a plan view illustrating a structure of a wireless device according to the present embodiment.

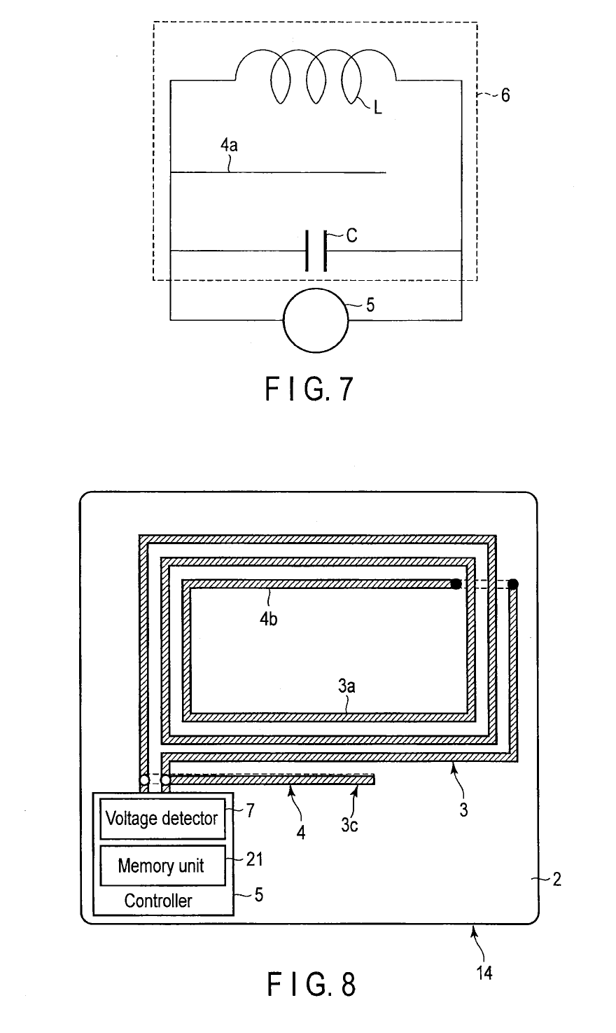

FIG. 7 is a circuit diagram illustrating the wireless device according to the present embodiment.

In a wireless device 13, the L-shaped pattern 4a of the wireless LAN antenna 4 is connected to the loop antenna 3a of the NFC antenna 3. As described above, the shape of the wireless LAN antenna 4 can be properly changed.

In the present embodiment, a capacitor 3c of the NFC antenna 3 is formed of a plurality of capacitor patterns. The capacitor patterns are conductors and formed to a front surface and a back surface of the board 2. An end of the capacitor pattern on the front surface side is connected to a part between one end of the loop pattern 3a and the controller 5. One end of the capacitor pattern on the back surface side is connected to a part between the other end of the loop pattern 3a and the controller 5. The capacitor patterns of the capacitor 3c may be formed of, for example, copper, or another conductor.

The L-shaped pattern 4a of the wireless LAN antenna 4 is electrically connected to the loop pattern 3a (for example, a spiral portion of the loop pattern 3a).

The present embodiment can obtain the same effect as that of the first embodiment. In addition, since the wireless LAN antenna 4 is formed inside the NFC antenna 3 in the present embodiment, the space for the antenna can be more reduced.

Also in the present embodiment, part of the NFC antenna 3 can be used as a wireless LAN antenna ground 4b, like the first embodiment. This structure achieves reduction in space for the wireless antenna.

In the present embodiment, the length of the wireless LAN antenna 4 can be adjusted, and the frequency thereof can be adjusted.

### Third Embodiment

The present embodiment shows a wireless device that is a modification of the first and second embodiments, and has a structure in which at least part of the capacitor 3c is used as the wireless LAN antenna 4.

FIG. 8 is a plan view illustrating a structure of a wireless device according to the present embodiment.

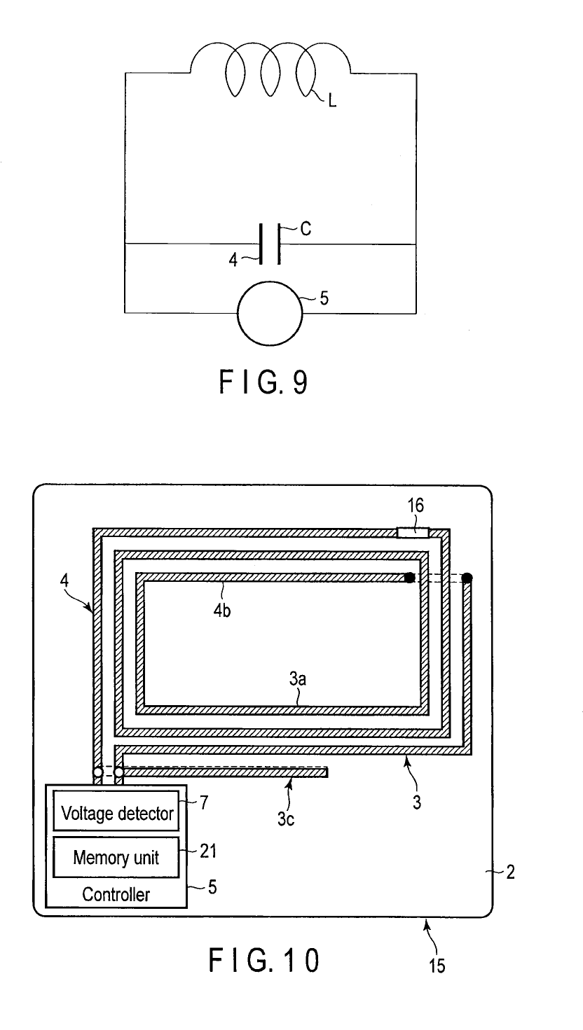

FIG. 9 is a circuit diagram illustrating the wireless device according to the present embodiment.

In a wireless device 14, at least part of the capacitor 3c of the NFC antenna 3 is used as at least part of the wireless LAN antenna 4. More specifically, the capacitor 3c is formed of a plurality of capacitor patterns formed to the front surface and the back surface of the board 2, as explained in the second embodiment. The wireless LAN antenna 4 according to the present embodiment corresponds to at least part of the capacitor patterns of the capacitor 3c. In addition, the antenna ground 4b of the wireless LAN antenna 4, that is, a signal ground for the wireless LAN antenna 4 is provided by the loop pattern 3a of the NFC antenna 3.

As explained above, according to the present embodiment, the capacitor 3c includes the capacitor patterns formed to the front and back surfaces of the board 2. In addition, at least part of the capacitor patterns of the capacitor 3c of the front surface, the back surface, or both the front and back surfaces is used as the wireless LAN antenna 4.

Thereby, it is unnecessary for the wireless device 14 to include a separate wireless LAN antenna 4 independently. This structure reduces the space for the wireless antenna, the number of components of the wireless device 14, and the manufacturing cost of the wireless device 14.

### Fourth Embodiment

The present embodiment shows a wireless device that is a modification of the first to third embodiments, and has a structure in which part of the NFC antenna 3 is used as at least part of the wireless LAN antenna 4.

FIG. 10 is a plan view illustrating a structure of a wireless device according to the present embodiment.

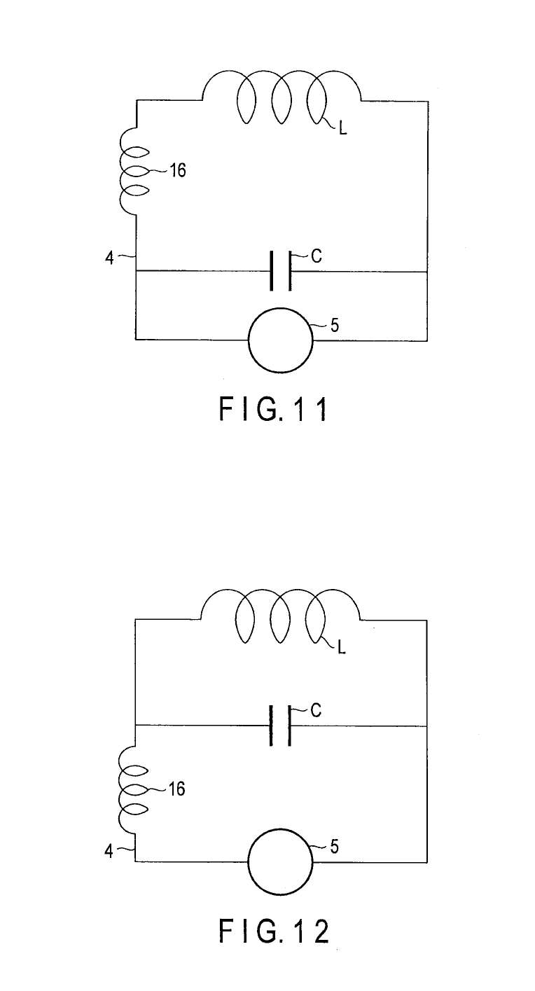

FIG. 11 is a circuit diagram illustrating the wireless device according to the present embodiment.

In a wireless device 15, an inductor 16 is provided in the loop pattern 3a of the NFC antenna 3.

The inductor 16 lets a current that is less than a predetermined frequency pass through, and does not let a current that is equal to or higher than the predetermined frequency pass through. For example, the inductor 16 filters out a middle or high frequency current.

In the present embodiment, the wireless LAN antenna 4 corresponds to a pattern between the controller 5 and the inductor 16, among the loop pattern 3a of the NFC antenna 3.

The frequency of NFC is 13.56 MHz, and the frequency of wireless LAN is 2.4 GHz. The frequencies are different from each other.

An electric current of middle or high frequency generated based on wireless LAN does not pass through the inductor 16. Thus, the current of middle or high frequency only flows through the part of the wireless LAN antenna 4 between the controller 5 and the inductor 16, among the NFC antenna 3.

In contrast, an electric current of low frequency generated based on NFC passes through the inductor 16. Thus, the current of low frequency flows through the NFC antenna 3.

Although the NFC antenna 3 and the wireless LAN antenna 4 are switched by using a current filtering function of the inductor 16, a switch may be provided instead of the inductor 16. The switch connects or disconnects the loop pattern 3a, based on a control by the controller 5. The controller 5 opens the switch (disconnected state) when wireless LAN is used, and closes the switch (connected state) when NFC is used. The case of using the switch will be specifically explained in a sixth embodiment described below.

Although the inductor 16 is provided in the loop pattern 3a in the present embodiment, the position of the inductor 16 is not limited to it. For example, the inductor 16 may be provided between the controller 5 and a capacitor C, as illustrated in FIG. 12. In this case, the wireless LAN antenna 4 corresponds to a pattern between the controller 5 and the inductor 16. Providing the inductor 16 between the controller 5 and the capacitor C is effective in the case where the wireless LAN antenna 4 can be short.

As explained above, according to the present embodiment, the inductor 16 is mounted to an antenna switching position of the NFC antenna 3. The inductor 16 can switch the used part of the wireless antenna, based on the difference in frequency characteristics between NFC and wireless LAN. Specifically, the inductor 16 can stop the flow of the current of middle or high frequency, and switch the shape of the wireless antenna between NFC and wireless LAN.

Since part of the NFC antenna 3 also serves as the wireless LAN antenna 4 in the present embodiment, the present embodiment can achieve reduction in space for the wireless antenna.

### Fifth Embodiment

The present embodiment shows a wireless device that is a modification of the first embodiment, and has a structure in which a setting position of the capacitor 3b is located in the loop pattern 3a of the NFC antenna 3, and thereby part of the NFC antenna 3 is used as at least part of the wireless LAN antenna 4.

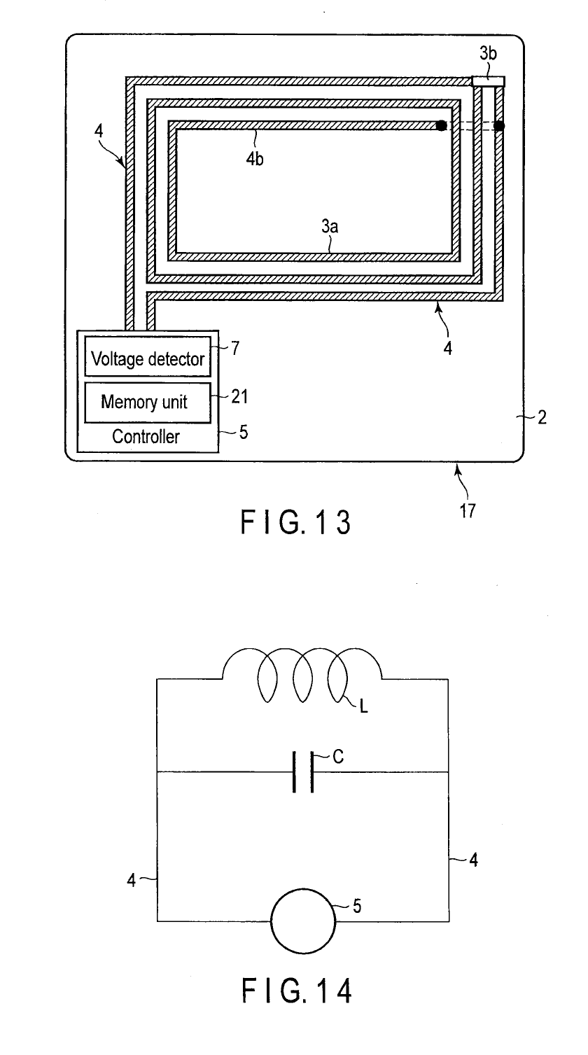

FIG. 13 is a plan view illustrating a structure of a wireless device according to the present embodiment.

FIG. 14 is a circuit diagram illustrating the wireless device according to the present embodiment.

In a wireless device 17, the capacitor 3b is provided in the loop pattern 3a of the NFC antenna 3.

The wireless LAN antenna 4 is formed between one end of the controller 5 and one end of the capacitor 3b, and between the other end of the controller 5 and the other end of the capacitor 3b, among the loop pattern 3a.

The other part of the NFC loop pattern 3a, which is not the wireless LAN antenna 4, is used as the wireless LAN antenna ground 4b.

In the present embodiment explained above, the part of the loop pattern 3a of the NFC antenna 3 extending from the controller 5 to the capacitor 3b is used as the wireless LAN antenna 4, and the part of the loop pattern 3a of the NFC antenna 3 other than the wireless LAN antenna 4 is used as the wireless LAN antenna ground 4b. This structure enables omission of the ground area, and reduction in space for the wireless antenna.

In addition, the length of the wireless LAN antenna 4 can be increased in the present embodiment.

### Sixth Embodiment

The present embodiment shows a memory card including one of the structures of the wireless devices 1, 8, 13, 14, 15, and 17 explained in the first to fifth embodiments.

Although the present embodiment shows an example of the case where the wireless device has a function of switching NFC with wireless LAN using a switch briefly explained in the fourth embodiment, the same is applicable to the case of including the other structures described above.

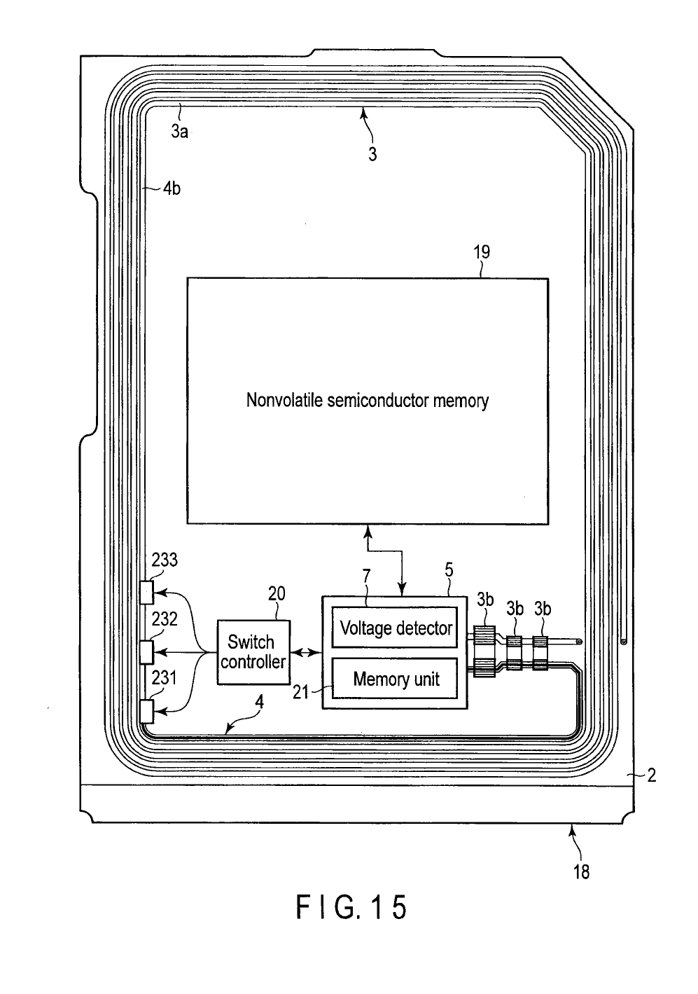

FIG. 15 is a diagram illustrating a front surface side of the memory card according to the present embodiment.

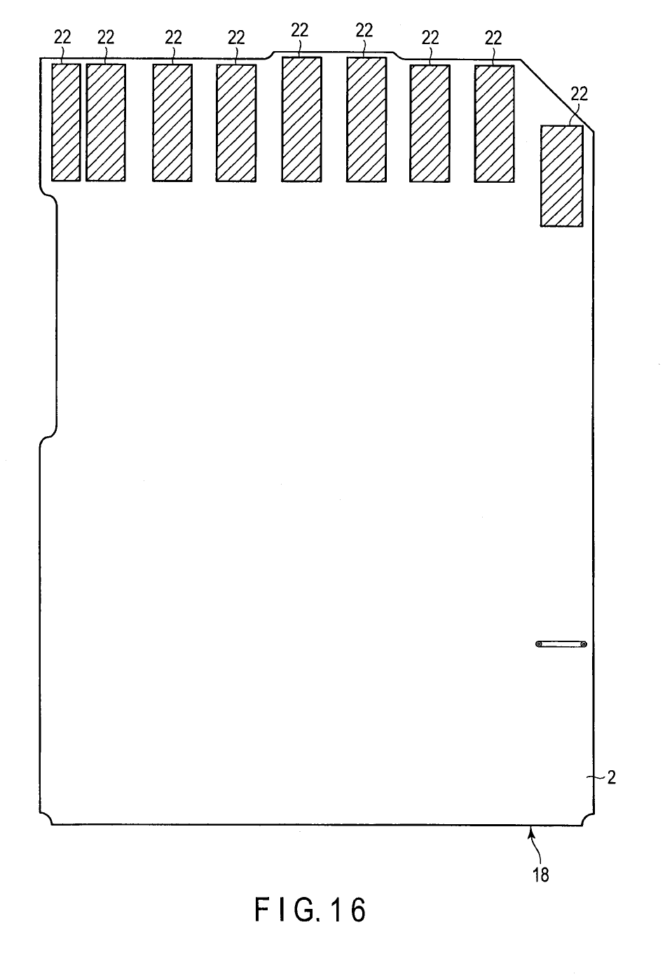

FIG. 16 is a diagram illustrating a back surface side of the memory card according to the present embodiment.

The memory card 18 includes the board 2, the NFC antenna 3, the wireless LAN antenna 4, the controller 5, a nonvolatile semiconductor memory 19, a switch controller 20, switches 231 to 233, and connection terminals 22.

The front surface of the board 2 is a mount surface, and the back surface thereof includes the connection terminals 22.

The nonvolatile semiconductor memory 19 is, for example, a NAND flash memory. However, the nonvolatile semiconductor memory 19 may be another nonvolatile semiconductor memory, such as a NOR flash memory, an MRAM (Magnetoresistive Random Access Memory), a PRAM (Phase Change Random Access Memory), a ReRAM (Resistive Random Access Memory), and an FeRAM (Ferroelectric Random Access Memory).

A main part of an antenna wire of the NFC antenna 3 is formed in an outer edge portion of the front surface of the board 2. This structure enables increase in the opening area of the center part of the loop pattern 3a.

The controller 5, the nonvolatile semiconductor memory 19, and the switch controller 20 are formed in an inside portion on the front surface of the board 2.

At least part of the NFC antenna 3 may be formed to the back surface of the board 2.

The switches 231 to 233 are provided in series in the loop pattern 3a. Although the number of the switches is three in the present example, the number of switches may be changed as desired.

All the switches 231 to 233 are closed when the wireless communication is NFC communication, to change the loop pattern 3a to the connected state.

On the other hand, when wireless communication is wireless LAN communication, one of the switches 231 to 233 is opened and the other two of the switches are closed in accordance with the frequency, to disconnect the loop pattern 3a based on a length corresponding to the frequency.

The wireless LAN antenna 4 is formed of a pattern between the controller 5 and the opened switch of the switches 231 to 233, among the loop pattern 3a of the NFC antenna 3.

The controller 5 writes writing data to the nonvolatile semiconductor memory 19 when receiving a write command and the writing data. The controller 5 reads reading data from the nonvolatile semiconductor memory 19 when receiving a read command. The controller 5 detects frequencies of signals generated in the wireless LAN antenna 4 and the NFC antenna 3, and communicates by wireless LAN communication and NFC communication based on the detected frequencies. Specifically, the controller 5 includes an NFC communication controlling function, a wireless LAN communication controlling function, a function of controlling transmission and reception to and from the nonvolatile semiconductor memory 19, a function of switching transmission and reception for a wireless LAN base band, a wireless LAN transceiver, and the wireless LAN, and a Balun function.

In the present embodiment, the voltage detector 7 of the controller 5 transmits a detected voltage to the switch controller 20.

The switch controller 20 determines whether to connect or disconnect each of the switches 231 to 233 in accordance with the frequency, based on the voltage detected by the voltage detector 7, and controls the connected state and the disconnected state of the switches 231 to 233.

For example, when NFC communication is performed, the switch controller 20 closes all the switches 231 to 233. For example, when wireless LAN communication is performed, the switch controller 20 determines the switch to be opened among the switches 231 to 233 to adjust the frequency of wireless LAN, and opened the determined switch.

Switching of the switches 231 to 233 by the switch controller 20 is performed when no current is flowing through the wireless antenna. The voltage detector 7 detects that no current is flowing through the wireless antenna.

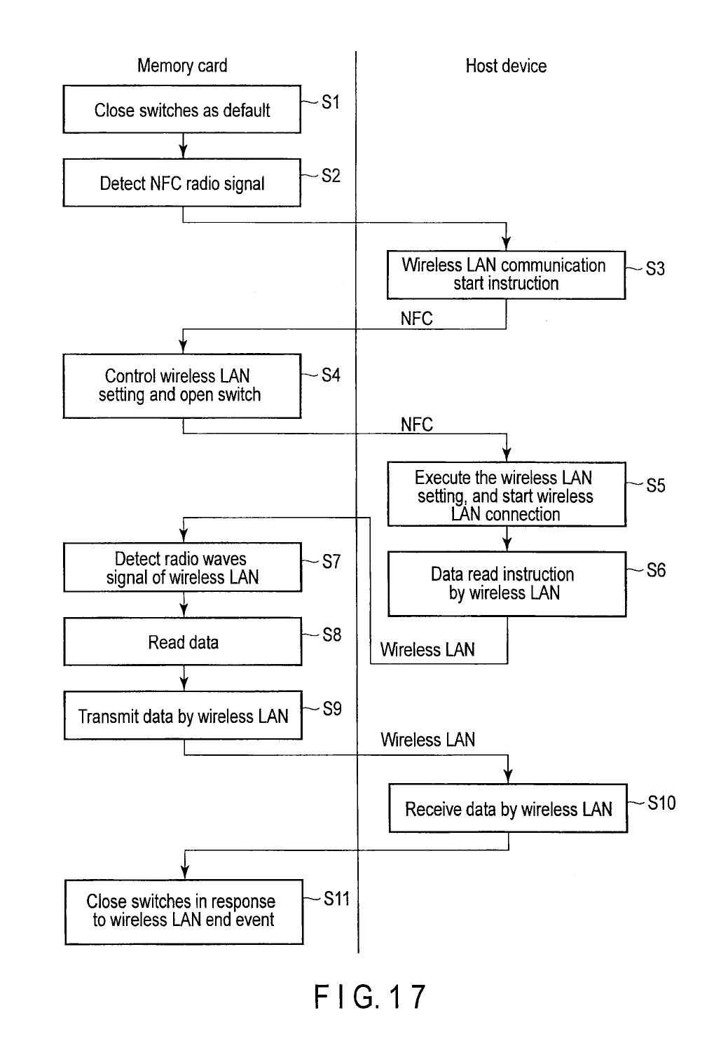

FIG. 17 is a flowchart illustrating wireless communication between the memory card 18 and the host device according to the present embodiment. For example, a portable information terminal is used as the host device.

In Step S1, the switch controller 20 of the memory card 18 closes the switches 231 to 233 as a default state.

In Step S2, the controller 5 of the memory card 18 detects a radio wave of NFC by the NFC antenna 3.

In Step S3, the host device transmits a wireless LAN communication start instruction to the memory card 18 by NFC.

In Step S4, the controller 5 of the memory card 18 receives the wireless LAN communication start instruction by NFC, controls the wireless LAN setting (access point (SSID), password), and transmits the wireless LAN setting to the host device by NFC. The switch controller 20 opens one of the switches 231 to 233 when the switch controller 20 receives the wireless LAN communication start instruction from the host device by NFC.

In Step S5, the host device executes the wireless LAN setting, and starts wireless LAN connection.

In Step S6, the host device transmits a data read instruction and an address to the memory card 18 by wireless LAN.

In Step S7, the memory card 18 detects a radio wave of wireless LAN by the wireless LAN antenna 4, and receives the data read instruction and the address.

In Step S8, the controller 5 of the memory card 18 reads out data from the nonvolatile semiconductor memory 19, based on the data read instruction and the address.

In Step S9, the controller 5 of the memory card 18 transmits the read data to the host device by wireless LAN.

In Step S10, the host device receives the data by wireless LAN.

In Step S11, the controller 5 of the memory card 18 performs a control by NFC when a wireless LAN end event occurs. The switch controller 20 closes the switches 231 to 233.

The wireless LAN end event includes at least one of receiving a wireless LAN end instruction from the host device, stop of power supply to the memory card 18, and lapse of a predetermined time.

In the present embodiment described above, the length of the wireless LAN antenna 4 can be switched according to the frequency, and wireless LAN communication can be performed in a good condition.

According to the present embodiment, it is possible to secure a large opening area for the center part of the loop pattern 3a of the NFC antenna 3, and secure sufficient electric power generated by electromagnetic induction.

In the present embodiment, the wireless device can access the same nonvolatile semiconductor memory 19 from the wireless antennas compliant with both the wireless LAN standard and the NFC standard, and the convenience of the memory card 18 can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless device comprising:
a first antenna;
a second antenna including a loop pattern and a capacitor; and
a controller configured to communicate by first communication using the first antenna and a ground, and communicate by second communication using the second antenna, the ground electrically connected to the loop pattern.

2. The wireless device of claim 1, wherein
the first antenna is used for a radio wave of a first frequency band, and
the second antenna is used for a radio wave of a second frequency band which is less than the first frequency band.

3. The wireless device of claim 2, wherein
the first antenna is a wireless LAN antenna,
the second antenna is an NFC (Near Field Communication) antenna,
the first communication is wireless LAN (Local Area Network), and
the second communication is NFC.

4. The wireless device of claim 1, wherein
the first antenna is set with a first frequency,
the second antenna is set with a second frequency, and
the controller starts the first communication when receiving a signal of the first frequency and receiving electric power from a power supply device, and starts the second communication when receiving a signal of the second frequency.

5. The wireless device of claim 1, further comprising:
a memory unit that is operable by electric power generated in the second antenna,
wherein the controller writes data to the memory unit when receiving electric power generated in the second antenna, the data, and a write command, and reads the data from the memory unit when receiving electric power generated in the second antenna and a read command.

6. The wireless device of claim 1, wherein
the first antenna includes an L-shaped or F-shaped pattern, and
the L-shaped or F-shaped pattern is electrically connected to the loop pattern.

7. The wireless device of claim 1, wherein
the capacitor includes capacitor patterns which are conductors and formed on a front surface and a back surface of a board, and
the first antenna is at least part of the capacitor patterns.

8. The wireless device of claim 1, further comprising:
an inductor included in the loop pattern and configured to filter out an electric current of a frequency equal to or higher than a predetermined frequency,
wherein the first antenna includes a pattern between the controller and the inductor, among the loop pattern.

9. The wireless device of claim 1, further comprising:
a switch included in the loop pattern and configured to connect or disconnect the loop pattern; and
a switch controller that opens the switch when communicating by the first communication, and closes the switch when communicating by the second communication,
wherein the first antenna includes a pattern between the controller and the switch, among the loop pattern.

10. The wireless device of claim 9, wherein
the controller communicates by the second communication in a default state, and communicates by the first communication when the controller receives a first communication start instruction, and
the switch controller closes the switch in the default state, and opens the switch when the controller receives the first communication start instruction by the second communication.

11. The wireless device of claim 10, wherein
the controller communicates by the second communication when a first communication end event occurs, the first communication end event includes at least one of reception of a first communication end instruction, stop of power supply, and lapse of a predetermined time, and
the switch controller closes the switch when the first communication end event occurs.

12. The wireless device of claim 1, further comprising:
a plurality of switches provided in series in the loop pattern and configured to connect or disconnect the loop pattern; and
a switch controller that determines and opens one of the switches to adjust a frequency of the first communication when communicating by the first communication, and closes the opened one switch when communicating by the second communication,
wherein the first antenna includes a pattern between the controller and the opened one switch among the switches.

13. The wireless device of claim 1, wherein
the capacitor is included in the loop pattern, and
the first antenna includes a pattern between the controller and the capacitor, among the loop pattern.

14. A memory card comprising:
a nonvolatile semiconductor memory;
a first antenna;
a second antenna including a loop pattern and a capacitor; and
a controller configured to communicate by first communication using the first antenna and a ground, communicate by second communication using the second antenna, write writing data to the nonvolatile semiconductor memory when receiving a write command and the writing data and receiving electric power from a power supply device, and read reading data from the nonvolatile semiconductor memory when receiving a read command and receiving electric power from the power supply device, the ground electrically connected to the loop pattern.

15. The memory card of claim 14, further comprising:
a memory unit that is operable by electric power generated in the second antenna,
wherein the first antenna is set with a first frequency,
the second antenna is set with a second frequency, and
the controller starts the first communication when receiving a signal of the first frequency and receiving electric power from the power supply device, starts the second communication when receiving a signal of the second frequency, writes data to the memory unit when receiving electric power generated in the second antenna, the data, and a data write command, and reads the data from the memory unit when receiving electric power generated in the second antenna and a data read command.

16. The memory card of claim 14, further comprising:
an inductor included in the loop pattern and configured to filter out an electric current of a frequency equal to or higher than a predetermined frequency,
wherein the first antenna includes a pattern between the controller and the inductor, among the loop pattern.

17. The memory card of claim 14, further comprising:
a switch included in the loop pattern and configured to connect or disconnect the loop pattern; and
a switch controller configured to open the switch when communicating by the first communication, and close the switch when communicating by the second communication,
wherein the first antenna includes a pattern between the controller and the switch, among the loop pattern.

18. The memory card of claim 17, wherein
the controller communicates by the second communication in a default state, and communicates by the first communication when the controller receives a first communication start instruction, and
the switch controller closes the switch in the default state, and opens the switch when the controller receives the first communication start instruction by the second communication.

19. The memory card of claim 18, wherein
the controller communicates by the second communication when a first communication end event occurs, the first communication end event includes at least one of reception of a first communication end instruction, stop of power supply, and lapse of a predetermined time, and
the switch controller closes the switch when the first communication end event occurs.

20. The memory card of claim 14, wherein
the loop pattern is formed in an outer edge portion on a board, and
the controller and the nonvolatile semiconductor memory are formed in an inside portion on the board.
